(19) United States
(12) Patent Application Publication
(10) Pub. No.: US 2007/0126290 A1
(43) Pub. Date: Jun. 7, 2007

(54) Systems and methods for powering an electronic device from selectable power sources

(76) Inventors: Stephen R. Jaynes, Pleasant Grove, UT (US); Paul Marshall, Mapleton, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/593,709

(22) Filed: Nov. 1, 2006

Related U.S. Application Data
(60) Provisional application No. 60/732,426, filed on Nov. 1, 2005.

(51) Int. Cl. H02J 7/00

(52) U.S. Cl. 307/150; 307/107; 710/62

(57) ABSTRACT

Systems and methods for powering and/or charging the battery of an electronic device from selectable power sources. A powering device is provided having multiple contacts or connections such that any electronic device can be powered by any power source through utilization of the powering device. In one implementation, the device includes an adapter to couple an electronic device (e.g., a cell phone, game console, iPod®, PDA, camera, computer device or any other portable electronics device) to a power source, wherein the adapter is a vehicle cigarette lighter adapter, a 9 volt battery adapter, a wall socket adapter, a USB adapter, or another power source adapter. In a further implementation, the powering device includes a retractable cord that is selectively coupled to one of a variety of cell phone adapters to allow any type of cell phone to be charged using the device. Additionally, the powering device is used for providing power to a cell phone for purposes of operating the cell phone and/or charging the battery of the cell phone. More particularly, implementation of the present invention relates to adapting a variety of different power sources to provide power to a cell phone.

### RELATED APPLICATIONS

This application claims priority to U.S. Provisional Patent Application Ser. No. 60/732,426, filed Nov. 1, 2005, entitled APPARATUS FOR POWERING A CELL PHONE FROM SELECTABLE POWER SOURCES.

### BACKGROUND OF THE INVENTION

1. Field of the Invention

The present invention relates to charging a power source of an electronic device. In particular, the present invention relates to systems and methods for powering and/or charging the battery of an electronic device from selectable power sources.

2. Background and Related Art

Cell phones are a common feature for millions of users throughout the world. Many people now use cell phones as their primary mode of communication and, increasingly, cell phones are being used for data transmission, including web access, email access, networked games, and otherwise. While cell phone use may increase the productivity and flexibility with which people can transact business, the more cell phones are used, the more reliant users become on having a steady source of power for their cell phone devices.

Because of the relatively short time that a cell phone battery will power a cell phone, as well as the rechargeable nature of most cell phone batteries, it is imperative that cell phone users have ready access to power sources. Cell phones are typically sold with an accompanying power device that permits the cell phone to be powered from a standard alternating current source, such as a standard 110-volt power outlet in a home or office. Cell phones are also provided in many cases with automobile adapters to allow a cell phone to be powered from the standard power source provided within an automobile, such as a 12-volt cigarette lighter outlet. In addition, recent advances in electronics technology have allowed cell phone users to use a specialized coupling cord to power their phones directly from the USB port that is included on many personal computers. A separate cord is used for each power source connection. Thus, while powering or recharging the battery of a cell phone remains an ongoing requirement for a cell phone user, the user needs the appropriate cord to permit a connection between their cell phone and the available power source or else is unable to use the available power source to power their cell phone.

Thus, while techniques currently exist that are used to power cell phones, challenges still exist. Accordingly, it would be an improvement in the art to augment or even replace current techniques with other techniques.

### SUMMARY OF THE INVENTION

The present invention relates to charging a power source of an electronic device. In particular, the present invention relates to systems and methods for powering and/or charging the battery of an electronic device from selectable power sources.

Implementation of the present invention relates to a device having multiple contacts or connections such that any electronic device can be powered by any power source through utilization of the device. In one implementation of the present invention, the device includes an adapter to couple an electronic device, such as a cell phone, to a power source, wherein the adapter is a vehicle cigarette lighter adapter, a 9 volt battery adapter, a wall socket adapter, a USB adapter, or another power source adapter. Additionally, in a further implementation, the device includes a retractable cord that is selectively coupled to one of a variety of cell phone adapters to allow any type of cell phone to be charged using the device. Additionally, the device is used for providing power to a cell phone for purposes of operating the cell phone and/or charging the battery of the cell phone. More particularly, implementation of the present invention relates to adapting a variety of different power sources to provide power to a cell phone.

While the methods and processes of the present invention have proven to be particularly useful in the area of charging cell phone batteries, those skilled in the art can appreciate that the methods and processes can be used in association with any type of electronic device, including cell phones, game consoles, iPods®, PDAs, cameras, computer device or any other portable electronics device.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates an anterior view of a representative embodiment of the present invention;

FIG. 2 illustrates a posterior view of a representative embodiment of the present invention;

FIG. 3 illustrates a lateral view of a representative embodiment of the present invention;

FIG. 4 illustrates another lateral view of a representative embodiment of the present invention;

FIG. 5 illustrates an anterior view of another representative embodiment of the present invention;

FIG. 6 illustrates a circuitry block diagram of a representative embodiment of the present invention;

FIG. 7 illustrates a view of a representative embodiment of the present invention with selectively retractable power input sources in a retracted position;

FIG. 8 illustrates a view of a representative embodiment of the present invention with selectively retractable power input sources for DC power sources in an extended position and the power output source in an extended position;

FIG. 9 illustrates a view of a representative embodiment of the present invention with selectively retractable power input source for an AC power source in an extended position; and

FIG. 10 illustrates a side view of a representative embodiment of the present invention with a selectively retractable power input source for 12-volt DC power in an extended position and the power input source for a 9-volt DC power shown on the exterior of the housing.

### DETAILED DESCRIPTION OF THE INVENTION

In the following description of embodiments of the present invention, reference is made to the accompanying drawings, which form part thereof and which are shown by way of illustrating specific embodiments in which the invention may be practiced. It is to be understood that other embodiments may be utilized, and that instructional and functional changes may be made without departing from the scope of the present invention.

The present invention relates to charging a power source of an electronic device. In particular, the present invention relates to systems and methods for powering and/or charging the battery of an electronic device from selectable power sources.

Embodiments of the present invention relate to a powering device having multiple contacts or connections such that any portable electronic device can be powered by any power source through utilization of the powering device. In one embodiment, the device includes an adapter to couple an electronic device (e.g., a cell phone, game console, iPod®, PDA, camera, computer device or any other portable electronics device) to a power source, wherein the adapter is a vehicle cigarette lighter adapter, a 9 volt battery adapter, a wall socket adapter, a USB adapter, or another power source adapter. Additionally, in a further embodiment, the powering device includes a retractable cord that is selectively coupled to one of a variety of cell phone adapters to allow any type of cell phone to be charged using the device. Additionally, the powering device is used for providing power to the portable electronics device for purposes of operating and/or charging the battery of the portable electronics device. At least some embodiments of the present invention relate to adapting a variety of different power sources to provide power to a portable electronics device.

While the following discussion relates to the powering of a cell phone battery, those skilled in the art will appreciate that embodiments of the present invention embrace the powering of any type of electronics device, including a cell phone, game console, iPod®, PDA, camera, computer device or any other portable electronics device.

In one embodiment, a cell phone user is enabled to provide power to a cell phone using a variety of direct current (DC) sources, such as, for example, a car battery, a 9 volt dry cell battery, or the USB port on a computer. At least some embodiments of the present invention also allow a cell phone user to provide power to a cell phone using an alternating current (AC) source, such as a 110-volt or 220-volt standard power outlet as commonly used throughout the industrialized world.

In one embodiment, the present invention integrally combines access to multiple sources of power into a single adaptor contained within a pre-molded housing that is lightweight and sized to be conveniently carried in the hand of a user. This embodiment allows the user to access a variety of power sources without having to carry individual adapters or converters designed for a single power source.

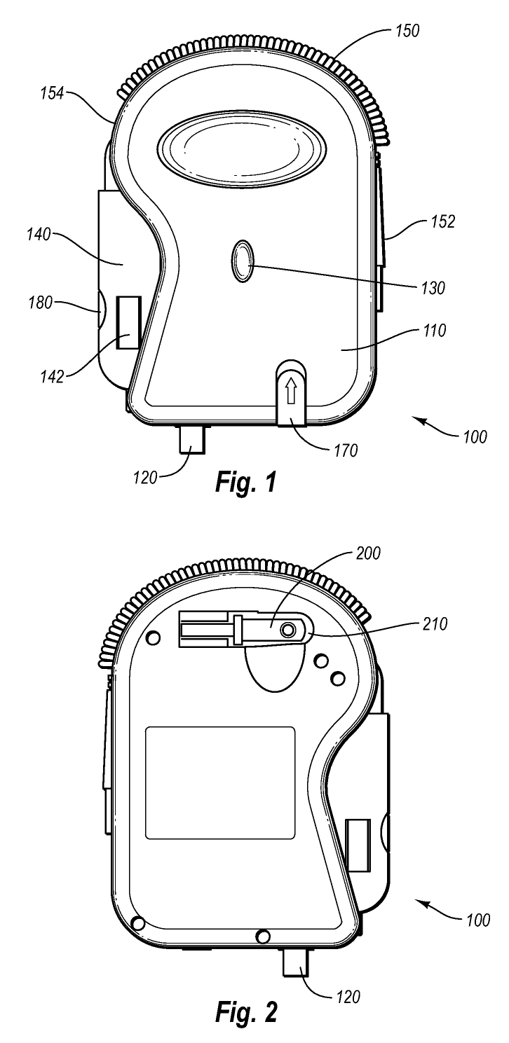

FIG. 1 is an anterior view illustrating the present invention as a partially integrated apparatus 100 with a housing 110, a power output source 120, and a status indicating light source 130. Housing 110 may be formed of molded plastic, machined or stamped metal, fiberglass, composites, or any similar material known in the art that is suitable for forming a housing. In one embodiment, power output source 120 is made of a molded plastic adapting head with two pins located inside. The molded plastic head is connected to a retractable, plastic-coated wire that terminates at an integrated circuit located inside the housing 110. The two-pin molded plastic may be coupled with any adapter suitable for a cellular phone, as is commonly known in the art. The status indicating light source 130 may be a light emitting diode (LED), a liquid crystal display (LCD), a standard filament light bulb, or another type of visual or other indicator that the device is functioning as expected while powering a cell phone. In addition, in one embodiment of the present invention, status indicating light source 130 is an indicator capable of indicating via multiple components that the apparatus is activated, and also indicating the amount of charge held by the battery of a cell phone that is connected to the apparatus.

FIG. 1 further illustrates a DC power plug 140 with DC power plug contacts 142, and a USB coupling link 150, having USB adapter end 152 and USB power outsource end 154 connected to housing 110. As illustrated in this embodiment, the DC power plug 140 fits a standard cigarette lighter socket found in most automobiles. The USB coupling link 150 has a USB adapter end 152 adapted to plug into a standard USB port found on many computers, and a USB power outsource end 154 that is fixedly connected to housing 110. In one embodiment, USB coupling link 150 is hingedly connected to housing 110 to permit positioning of USB coupling link 150 so as to minimize the profile of this embodiment. Accordingly, a user of one embodiment of the present invention may operate his or her cell phone while sitting in front of a computer or while riding in a car. In addition, FIG. 1 illustrates a mechanical retraction activation member 170, which upon activation will automatically retract the power output source 120 back into the housing 110. When a user applies pressure to retraction activation member 170, the wire attached to power output source 120 is automatically and quickly drawn back into the apparatus. This retraction activation member 170 may be powered by a spring, or any other mechanism commonly known in the art. In addition, DC power plug 140 includes a power surge protection device 180, which may be a fuse, as illustrated in FIG. 1, or any other circuit protection means known in the art.

FIG. 2 illustrates a posterior view of one embodiment of the present invention with AC power plug 200 illustrated as a standard two-blade plug, which, when rotated from a first storage position to a second operating position can be inserted into a standard power outlet of either 110 or 220 volts. In various embodiments, AC power plug 200 may be of the shape or configuration that is standard in North America, Japan, Europe, or any other country or region. The AC power plug 200 may optionally include a three-pin grounded formation. AC power plug nook 210 enclosed the majority of AC power plug 200 when in a first storage position, permitting a minimized profile of this embodiment. AC power plug nook 210 is molded into the surface of housing 110, and the AC power plug 200 may be either folded or retracted or hingedly placed into AC power plug nook 210 using mechanical means known in the art.

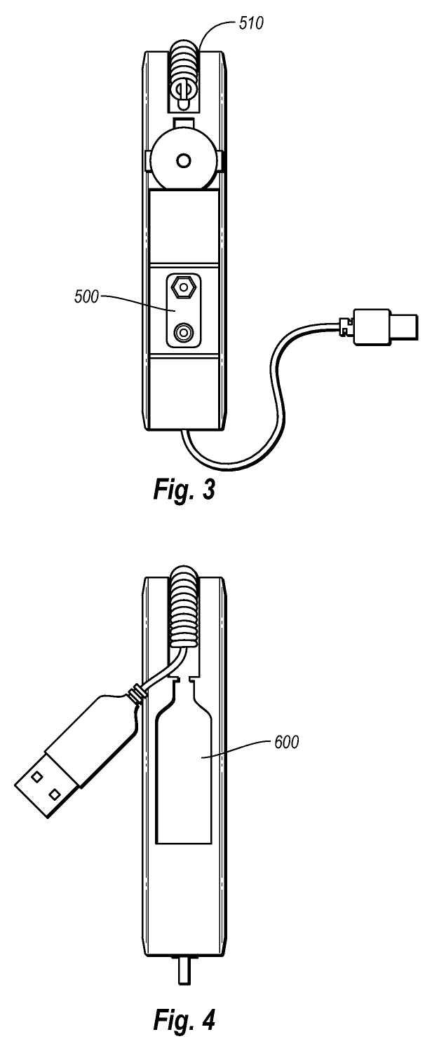

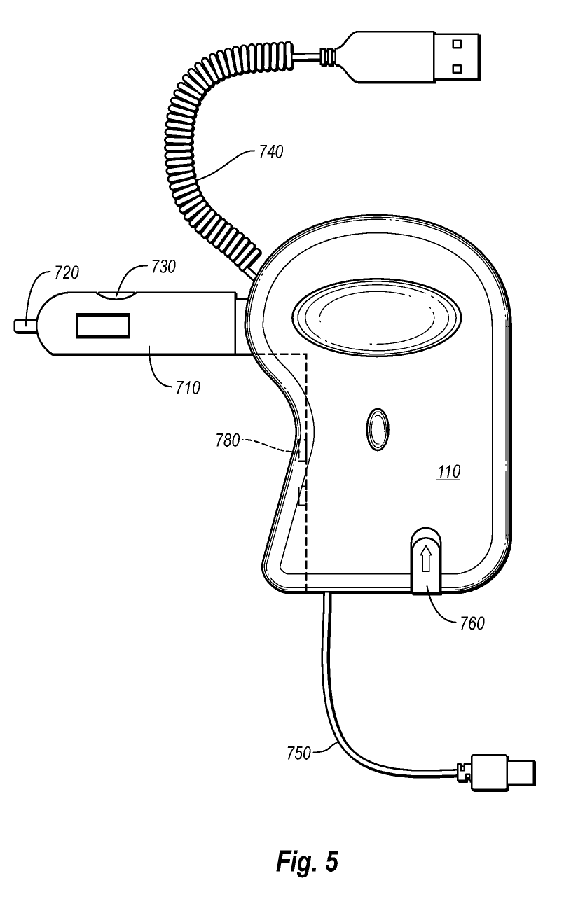

FIG. 3 illustrates a lateral view on right of an embodiment of the present invention, showing 9-volt jack 500 as a connector for an additional power source that can be utilized in this embodiment to power a cell phone. In addition, FIG. 5 illustrates USB nook 510 on the superior surface of this embodiment. USB nook 510 allows USB coupling link 150 to rest in a substantially flush position with the exterior outline of housing 110, thus reducing the profile of this embodiment.

FIG. 4 illustrates a lateral view on left of an embodiment of the present invention, showing USB plug nook 600 formed in housing 110. In this embodiment, USB plug nook 600 receives USB adapter end 152 of USB coupling link 150, which is maintained in position by friction or other means known in the art.

FIG. 5 illustrates an embodiment of the present invention in which DC power plug 710 is fixedly attached to housing 110. DC contacts 720 and power surge protector device 730 are visible on DC power plug 710. In addition, this embodiment illustrates USB coupling cord 740 integrally connected to housing 110. Power output source 750 extends from the posterior end of the housing 110, which can be connected to a variety of adaptors to supply power to a variety of different cell phones. When pressed by the user, mechanical retraction activation 760 will retract power output source 750, thus minimizing the profile of this embodiment. A 9-volt jack 780 may be included in this embodiment for coupled to a 9-volt battery source.

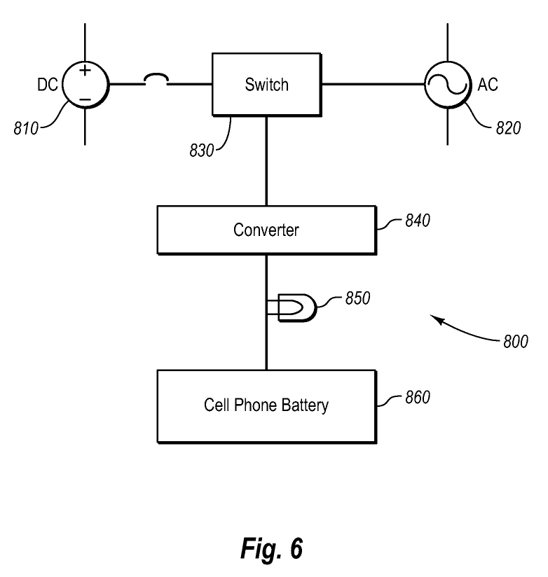

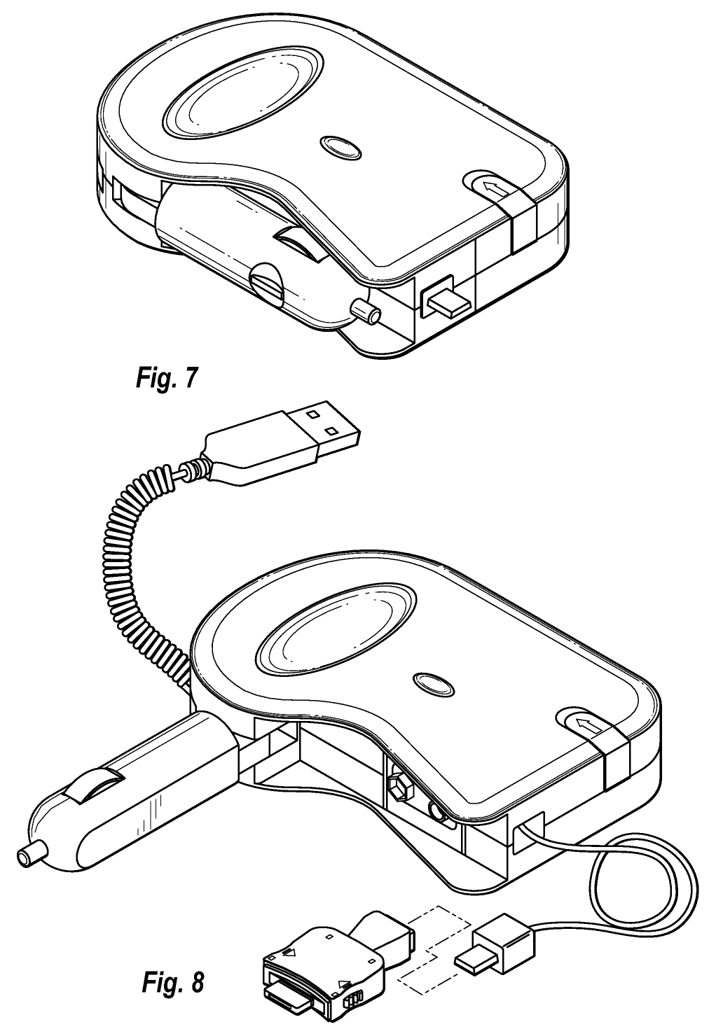

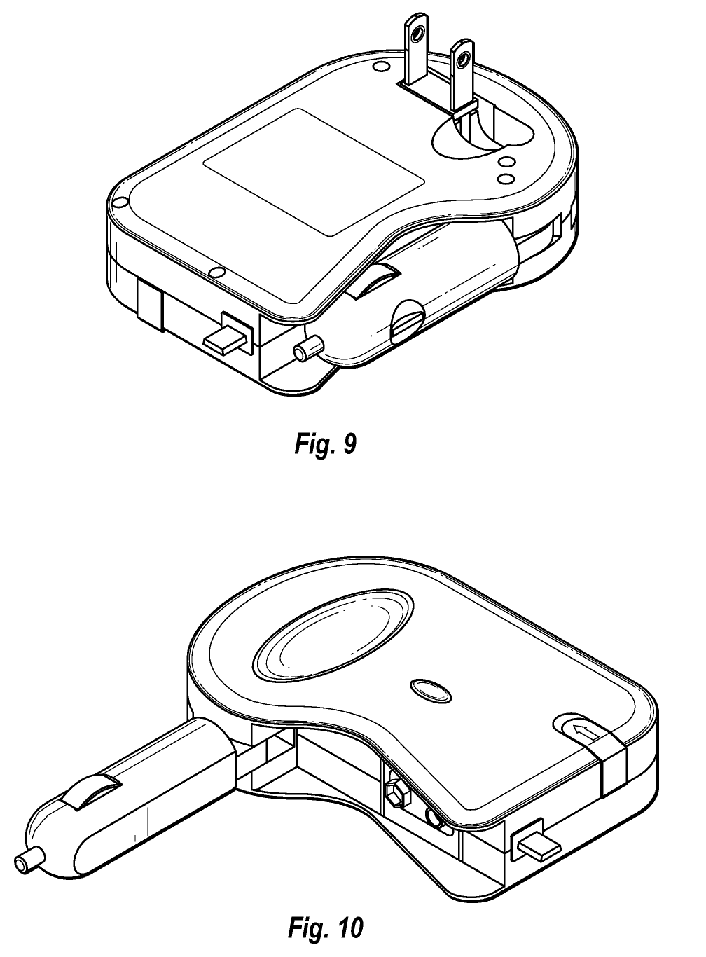

FIG. 6 illustrates converter circuitry 800 with at least one DC lead 810 and at least one AC lead 820 connected to switch 830. Switch 830 automatically determines which of the available leads has been connected to a power source, and adjusts appropriately. Switch 830 is a standard switch commonly known in the art. Switch 830 is electrically connected to converter 840, which comprises standard electrical components known in the art. Converter 840 converts current from DC lead 810 or AC lead 820 into the appropriate voltage required to power a cell phone. An option element that is electrically connected to converter 840 is indicator 850, which indicates via one or more visual or other cues that the device is activated to power a cell phone. The DC power source connected to DC lead 810 may be a 12-volt battery, via a connection as is commonly found in automobiles, or a USB port, as is commonly found on a personal laptop computer, or a standard 9-volt dry-cell battery. The AC power source connected to AC lead 820 may be either a 110-volt or a 220-volt power source, as is found throughout the industrialized world.

In one embodiment, the powering device comprises a detachable USB coil. In some embodiments, the powering device comprise interchangeable connector tips for selectively coupling to an electronics device.

Thus, as discussed herein, embodiments of the present invention embrace charging a power source of an electronic device. In particular, embodiments of the present invention relate to systems and methods for powering and/or charging the battery of an electronic device from selectable power sources.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An apparatus for coupling at least one of a plurality of power sources to an electronic: device, comprising;
a housing having a perimeter;
a plurality of power source adapters extending from the housing perimeter;
an electronic device adapter configured to couple to the electronic device; and
a converter circuit electrically coupled to the power source adapters and the electronic device adapter.

2. The apparatus of claim 1, wherein said housing is integrated with at least one of said power source adapters.

3. The apparatus of claim 1, wherein said housing is integrated with the electronic device adapter.

4. The apparatus of claim 1, further comprising a status indicator electrically connected to the circuit.

5. The apparatus of claim 1, wherein one or more of the plurality of power source adapters are selectively extending from the housing perimeter.

6. The apparatus of claim 1, wherein one or more of the plurality of power source adapters are selectively concealable in pre-formed receptacles within the housing.

7. The apparatus of claim 1, wherein the plurality of power source adapters comprises a DC power plug.

8. The apparatus of claim 1, wherein the plurality of power source adapters comprises an AC power plug.

9. The apparatus of claim 1, wherein the plurality of power source adapters comprises a USB plug.

10. The apparatus of claim 1, wherein the USB plug is a mini USB connector.

11. The apparatus of claim 1, wherein the plurality of power source adapters comprises a 9-volt jack.

12. The apparatus of claim 1, wherein the plurality of power source adapters comprises a two-pin socket.

13. The apparatus of claim 1, wherein at least a portion of a cord of said electronic device adapter is mechanically retractable to a position inside said housing.

14. The apparatus of claim 1, wherein the electronic adapter comprises one or more interchangeable connectors to selectively couple the electronic device adapter to the electronic device.

15. A method for powering an electronic device, the method comprising:
providing a powering apparatus having a plurality of power source adapters electrically connecting to an electronic device adapter;
selecting one of the plurality of power source adapters for use with an available power source;
coupling the selected power source adapter to the available power source;
coupling the electronic device adapter to an electronic device; and
powering the electronic device using the available power source.

16. A method as recited in claim 15, further comprising using a converter circuit of the powering apparatus to convert power from the available power source to a usable power output required by the electronic device.

17. A method as recited in claim 15, wherein said powering the electronic device comprises recharging a battery of the electronic device.

18. An electronic powering device, comprising;
a housing having a plurality of surfaces;
a plurality of power source adapters extending from the plurality of surfaces;
an electronic device adapter configured to couple to an electronic device; and
a converter circuit electrically coupled to the power source adapters and the electronic device adapter.

19. An electronic powering device of claim 18, wherein at least a portion of a cord of said electronic device adapter is mechanically retractable to a position inside said housing, and wherein the electronic device adapter comprises one or more interchangeable connectors to selectively couple the electronic device adapter to the electronic device.

20. An electronic powering device of claim 18, wherein the electronic device is a portable electronic device comprising one of:
(i) a cell phone;
(ii) a game console;
(iii) an electronic audio device;
(iv) an electronic video device;
(v) a personal digital assistant;
(vi) a camera; and
(vii) a computer device.
